(19) United States
(12) Patent Application Publication
(10) Pub. No.: US 2026/0071437 A1
(43) Pub. Date: Mar. 12, 2026

(54) TILE MODELS AND TILE ASSEMBLIES TO CREATE SURFACES WITH RARELY REPEATING DESIGNS AND SHAPES AT TRIANGULAR INTERSECTIONS OF THE TILE MODELS

(71) Applicant: Giovanni Barbieri, VICENZA (IT)

(72) Inventor: Giovanni Barbieri, VICENZA (IT)

(21) Appl. No.: 19/036,860

(22) Filed: Jan. 24, 2025

Related U.S. Application Data
(60) Provisional application No. 63/694,011, filed on Sep. 12, 2024.

(51) Int. Cl. E04F 13/08; B44C 1/18; E04F 15/02

(52) U.S. Cl. CPC E04F 13/0871; B44C 1/18; E04F 13/0885; E04F 15/0215; E04F 2203/02

(57) ABSTRACT

Tile models and tile assemblies create surfaces with rarely repeating designs and shapes at triangular intersections of the tile models. Each model has the same perimeter of 3 outer curvature shapes when at a first orientation angle. The outer curvature shapes include a female side having a first area shape removed and added to an adjacent male side which fits with no gaps into the female side of other tiles. Each tile model has 3 different internal top surface parts that project inwards from the 3 outer curvature shapes to 3 internal curvature shapes, and that are different than those of the other models. The 3 different internal surface parts are configured to create a surface with rarely repeating shapes at triangular intersections between 3 tile models with one model at the first orientation angle, a second model rotated by 120 degrees, and a third model rotated by 240 degrees.

### RELATED APPLICATION INFORMATION

This patent claims priority from provisional patent applications 63/694,011 filed Sep. 12, 2024, entitled SURFACE WITH NEVER-REPETITIVE DESIGNS AND SHAPES, the content of which is included by reference in this application in its entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to a limited number of tile models and tile assemblies of those tile models that create surfaces with rarely repeating designs and shapes at triangular intersections of the tile models.

### Related Art

Until now, it was not possible to create a composition of different, rarely repeating or almost never repeating shapes or designs at triangular intersections of a limited number of tile models to cover a wall or floor in ceramic tiles, marble or other materials. The market in the world of flooring and coverings is saturated with designs that are increasingly similar, sometimes boring and easily replicable in sad but necessary versions to obtain a certain production cost that allows a valid sales possibility.

The continuous search for useful solutions to obtain new creations with an extremely captivating and utterly unique design, created at accessible costs, is a useful way to stand out in the market and survive worthily with professional behavior not only on the market but above all towards of its employees and families.

After countless attempts and experiments, a new evolution in unique tile design has been achieved. Now, it has become possible with the current disclosure of less than a dozen tiles or tile models, to make a rarely repeating and aesthetically pleasing design with much lower cost of tiles and assembling of them.

### DESCRIPTION OF THE DRAWINGS

FIGS. 1A-1H describe a limited number of four tile models that can be used to form tile assemblies that create a surface with rarely repeating designs and shapes at triangular intersections of the tile models.

FIGS. 2A-2B describe a limited number of four tile models with arm splash shapes that can be used to form tile assemblies that create a surface with rarely repeating designs and shapes at triangular intersections of the tile models (e.g., triangular may include or be a ⅓ irregular part intersection of the same intersections of the tile models).

FIGS. 3A-3B describe a limited number of four tile models with one perimeter outer curvature shape and internal top surface part shape that can be used to form tile assemblies that create a surface with rarely repeating designs and shapes at triangular intersections of the tile models.

FIGS. 4A-4C describe a limited number of three tile models that can be used to form tile assemblies that create a surface with rarely repeating geometric designs at triangular intersections of the tile models.

FIGS. 5A-5D describe a limited number of six tile models that can be used to form tile assemblies that create a surface with rarely repeating designs and shapes at triangular intersections of the tile models.

FIGS. 6A-6B describe a limited number of six tile models having different thicknesses that can be used to form tile assemblies or compositions that create a surface with rarely repeating tile thickness designs and shapes at triangular intersections of the tile models.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

This disclosure relates to a limited number of tile models and tiles of those models that can be used in tile assemblies or installations that create surfaces with rarely repeating shapes designs and/or shapes at triangular intersections of the tiles. For example, it is possible with the simple standard industrial production of just 3, 4, 5, or 6 tile models herein to make a rarely repeating and aesthetically pleasing tile surface results at a much more reasonable cost as compared to other tiles, even considering the assembly or installation of the tiles according to the tile models herein.

In some cases, the use of a dozen or less (e.g., a limited number of between 3 and 12) tile models to create tile assembly textures that are rarely repetitive, could be used and/or produced in different percentages of each pattern or tile model used in the assembly, thus optimizing the production costs that could be cheaper for some of the patterns or blanks to be cut into tiles with reference to the raw material size available to cut on the market and the difficulty of cutting each individual model. This optimizing could reduce the production costs based on using more of a certain tile model (as compared to the other tile models used in the assembly) that is cheaper to produce due to cheaper blanks, cheaper types of raw materials and/or less needed amounts of mor expensive raw material for those certain tiles. This optimizing could reduce the production costs based on using more of a certain tile model (as compared to the other tile models used in the assembly) that is cheaper to produce due to being cheaper to cut the certain tile model and/or cheaper to buy the certain tile model as available on the market.

This use, selecting and/or optimizing allows a detailed study of the costs of (e.g., tiles of/or) tile models to be used in the assembly to be able to propose a version of proportions of different numbers of tiles of the tile models used in the assembly at the lowest cost while maintaining the assembly's uniqueness (e.g., rarely repeating and aesthetically pleasing result). This allows a detailed study of the costs of different tile models to be used in the assembly, and selection of different numbers of each of tiles of the different tile models used in the assembly to obtain a lowest or desired cost of all the tiles used, while maintaining the assembly's uniqueness. The same mixing of more or less different percentages of tiles per each tile model, can be used by any customer simply to satisfy each own customer's individual preference. The mixture of different numbers of tiles of each tile model for the assembly can be selected by a tile manufacturer, seller, assembler, purchaser or floor buying customer to satisfy their own individual preference of cost and/or desired assembly's uniqueness. This use, selecting and/or optimizing may include excluding certain tile models from being used in the assembly.

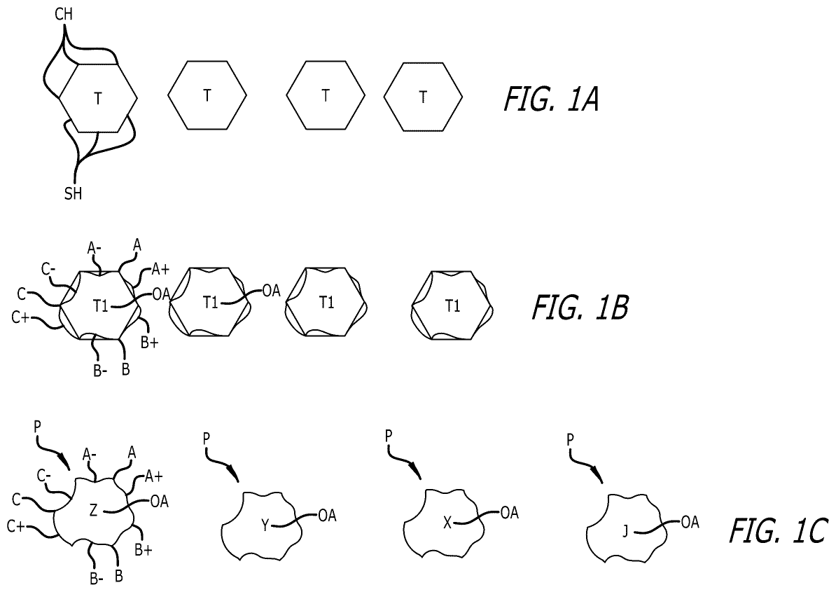

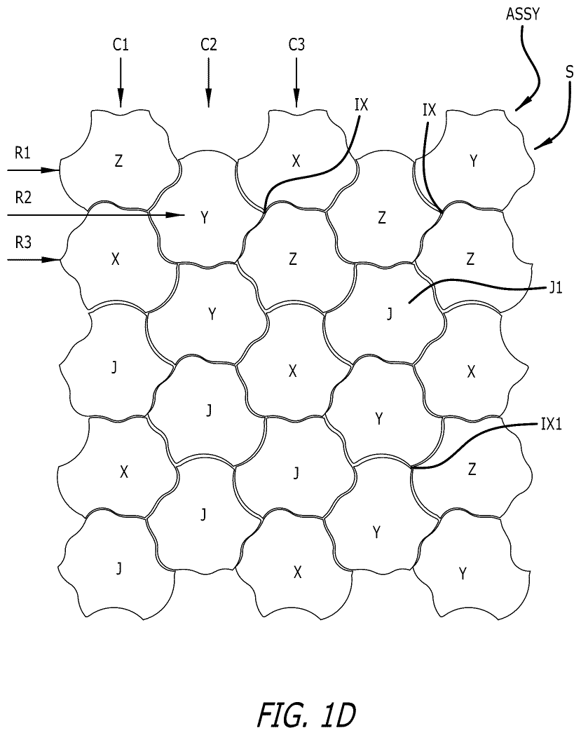

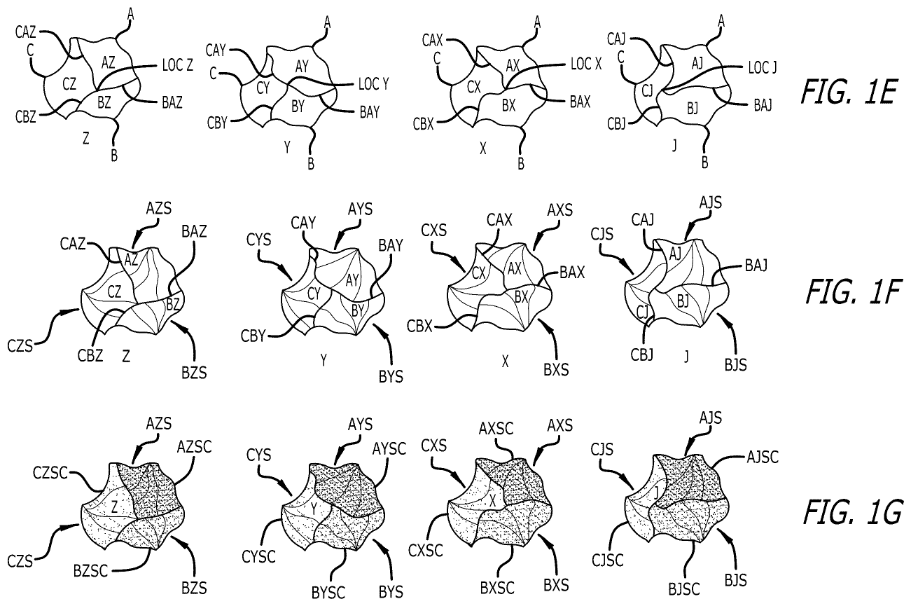

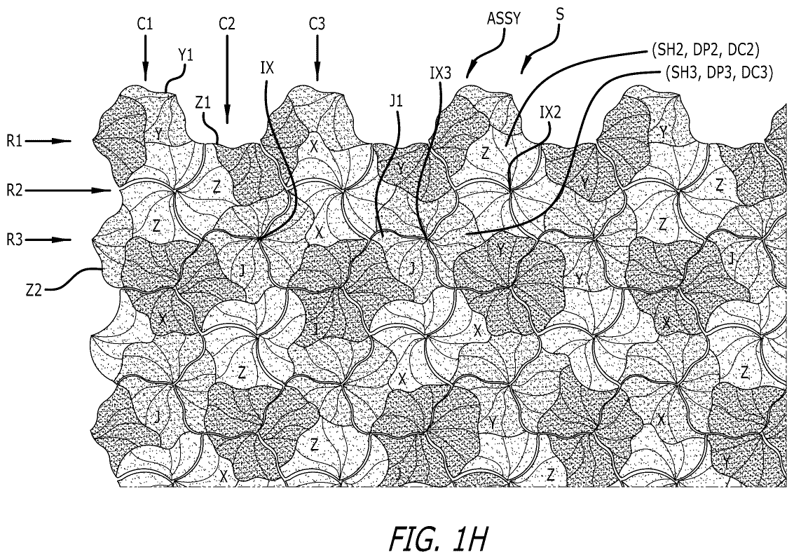

Tile models (and tiles of tile models) herein can be used not only to (e.g., be assembled to) form surfaces of floors or coverings but also to form surfaces of (e.g., coverings of) furniture, facades of buildings and other types of surfaces where this concept can be adapted. In some cases, designs of tile models can be used for a “Blooming” collection (e.g., see FIG. 1F) in wood produced in a reduced size and thickness to apply to the facade and doors of a piece of furniture.

Descriptions of a “tile”, “tile model” or “model of tiles” may be of or include a certain tile shape, design, mosaic, pattern, shape, collection, sample, instance, type, style, name of a tile such as of those herein. Descriptions of a “tile model” or “model of tiles” may be of a tile having a selected or specific perimeter shape, overall shape, material, design, color, size, etc. that a number of tiles will copy; and/or be manufactured based on or according to that model. Descriptions of a single tile or “tile” herein may be or include a tile modeled after a “tile model”, according to a “tile model”, or manufactured to be similar in perimeter shape, overall shape, material, design, color, size, etc. as a “tile model”. A tile may be one of many tiles that look and function exactly the same as a single tile model. There may be many tiles modeled after each of a limited number of tile models.

A “limited number” of the tiles or tile models may be 3. 4, 5, or 6 tiles or tile models. It may be between 3 and a dozen tiles or tile models. A limited number of tiles may be between four and six tiles or tile models. A limited number of tiles may be between 3 and 7 tiles or tile models. A limited number of tiles may be between 4 and 7 tiles or tile models.

Rarely repeating may refer to repeating every 5, 10, 20, 50, 100, almost never-repetitive or nearly never-repetitive designs and/or shapes at triangular intersections of intersections of three tiles of the tile models.

Triangular intersections of the tile models or tiles may include or be a ⅓ irregular part intersection (e.g., a ⅓ of the tile edges or a ⅓ pizza slice shaped surface) of the intersections of the three or tiles tile models. Triangular intersections of the tiles may be or include intersections of 3 different parts of 3 or tiles tile models that form shapes at the intersections that rarely repeats and/or an intersection of 3 different sectioned styles and/or colors of 3 or tiles tile models that form designs at the intersections that rarely repeat, such as using a limited number of the tile models as described herein.

FIGS. 1A-1H describe a limited number of 4 tile models Z, Y, X and J that can be used (e.g., tiles of those tile models used) to form tile assemblies or compositions that create a surface with rarely repeating designs and shapes at triangular intersections of the tile models, such as shown in FIG. 1H. FIG. 1A shows a top view of 4 tile models T each having a hexagonal perimeter shape with 6 corners CH and 6 sides SH. All the corners CH of tile models T may form a 120 degree interior angle and all the sides may have the same length. Maintaining the reference to the tile lateral junctions at the 3 corners A, B and C; the sides SH of tile models T are modified by installing them twice inverted on 2 joined sides. Using a starting point of a hexagon tile format allows for 6 sides that fit together, offering much higher versatility than a square format.

FIG. 1B shows a top view of 4 tile models T1 each having 6 perimeter side shapes A−, A+, B−, B+, C− and C+ overlaid over sides SH between the 6 corners CH. The 6 perimeter side shapes are 3 joined or adjacent pairs A−+, B−+ and C−+ of the sides having 3 outer curvature shapes A− and A+; B− and B+; and C− and C+ when each tile model is at a first orientation angle OA. FIG. 1B shows 3 arrows where each of the 3 outer curvature shapes includes a female (e.g., negative or internal) shaped side A−, B− and C− having the shape of a first area removed to form a female shaped side from side SH and an adjacent male (e.g., positive or external) shaped side A+, B+ and C+ having the corresponding shape of the first area added to it to form the male shaped side from side SH. The actual piece of material of the shape of a first area is not removed (e.g., cut away) to form a female shaped side from side SH and physically added (e.g., glued to) to the adjacent male shaped side. Instead, tiles are cut with the shapes of the tile models as described, without removing part of or adding material an actual tile. This applies to other descriptions of the tile models, assemblies, surfaces and tiles of those models.

FIG. 1C shows a top view of a limited number of 4 tile models Z, Y, X, and J each having a top surface (shown), a bottom surface (not shown) and the perimeter P of 6 perimeter sides A−, A+, B−, B+, C− and C+ between the 6 corners CH. The 6 perimeter sides form a generally 6 sided, hexagonal shape with 3 joined or adjacent pairs A−+, B−+ and C−+ of the sides having 3 outer curvature shapes A− and A+; B− and B+; and C− and C+ when each tile model is at a first orientation angle OA. The corresponding 2 sides of 3 adjacent pairs connect or have tile lateral junctions at corners A, B, and C as shown.

In some cases, the edges or perimeter shape of each single tile model and their assemblies, can be worked in a different or single way (e.g., variations) to create one or more (e.g., edges or perimeter shape) patterns that referred to themselves (e.g., at triangle intersections in an assembly with the other tiles of those models. In some cases, variations of each pair (e.g., A, B and C) of 6 perimeter side shapes A−, A+, B−, B+, C− and C+ can have 3 different shapes ABC as shown; two different shapes such as AAC, AAB, BBA, BBC, CCA or CCB; and/or one shape AAA, BBB or CCC. It is also possible to mix these variations. These variations may be used to not only better define each single shape or only the shape of each tile model but to also create partial or entire decorative aesthetical additional results of or based on the edges themselves, such as in compliance with an individual's preference.

Using a generally hexagonal shape or format of tile models Z, Y, X, and J has the versatility of being able to combine 6 sides to greatly enhance the possibilities of creating new designs that are much more versatile than a square shape or format; maintains the reference to the alternative 3 corners A, B, and C of the 6 corners CH; and/or modifies the sides SH as desired by installing them inverted (e.g., minus is removed and added at plus) on 2 joined or pairs of sides A−, A+, B−, B+, C− and C+. Each of tile models Z, Y, X, and J may be a tile model as they are not only individual tiles but multiple ones of them can be used in a set of 4 models of tiles Z, Y, X, and J that are used, assembled or installed to form tile assemblies ASSY and the like.

FIG. 1D shows a top view of a limited number of 4 tile models Z, Y, X, and J assembled into tile assembly ASSY that creates a surface S with rarely repeating designs and shapes (see FIG. 1H) at triangular intersections IX of the tile models. The apparent irregular shape of the 6 perimeter sides A−, A+, B−, B+, C−, and C+ provides a generally or irregular hexagon, which matches perfectly with the other identical ones, allowing a 120° rotation of each of the tile models compared to the previous one during installation to form assembly ASSY. Dividing the 6 sides SH into three pairs of sides or parts A, B, and C not only by modifying the 2 consecutive sides of the hexagon by curving them and making them opposite (e.g., female and male) allows the laying of another tile model joined with the same curved side of the 6 perimeter sides so that they are joined at A− and A+; B− and B+, and C− and C+ as shown. In some cases, the male shaped side of a tile A+; B+, and C+fits with no gaps (or a gap of up to 1, 2 or 3 millimeters) into a corresponding female shaped side A−; B−, and C−, respectively of another tile, as shown. Unexpected benefits of the tile models herein included that forming an assembly or surface of tiles of the tile models having curved perimeter sides provides better assembly joints than tiles having flat shaped perimeter sides because the curved perimeter sides do not slide sideways or along each other as flat tile sides can do. For example, flat or straight hexagon tile side, or any other shaped tile (square, rectangle) with flat sides can slide across each other and become out of place during assembly. The tiles of the tile modes herein do not slide past each other because the curved perimeter sides of adjacent tiles match up and do not slide because the curved shapes are mated with each other and create too much friction to slide sideways.

The tile assembly ASSY has columns C1, C2, and C3 and rows R1, R2, and R3 of random order sequences of tiles of the tile models Z, Y, X, and J. Each tile model is surrounded by 6 other tile models, with the exception of edge tiles. The tiles may be glued, adhered, nailed, screwed, epoxy, magnetically or otherwise attached to a surface below them, such as at their bottom surface. The tiles may be adjacent to each other, touching, joined or attached to each other at corresponding male shaped sides and female shaped sides, such that no gaps are formed between the corresponding male shaped sides and female shaped sides. In some cases, each of the 3 outer curvature shapes includes a female shaped side having a first area removed from the female shaped side and an adjacent male shaped side having a first area proportional to the first area removed from the female shaped side added to the male shaped side.

The sequence of tile models of assembly ASSY includes a first tile model, such as tile model J1, at the orientation angle OA and each tile model joined to the first tile model rotated by one of 120 degrees (e.g., ⅓) of a total clockwise rotation of OA; or 240 degrees (e.g., ⅔) of a total clockwise rotation of OA as compared to the orientation angle OA. For example, the tile models in row R1 are at orientation angle OA, the tile models in row R2 are rotated by 240 degrees clockwise from first orientation angle OA, and the tile models in row R3 are rotated by 120 degrees clockwise from first orientation angle OA.

Triangular intersections IX are shown where any 3 of the tile models meet. Intersections IX can be an intersections of any 3 of the tile models, at and/or including three corners of three different tile models. The tile models do not need to be different models of tiles but have the same or corresponding ones of corners A, B, or C of the 3 outer curvature shapes joined at the intersection. For example, intersection IX1 has the 3 corners C of tile models Y, Y, and Z. Each generally hexagonal shape of the internal top surface of the tile models may be divided into 3 different parts, recalled and delimited with each pair of curved sides or with each outer curvature shape.

FIG. 1E is a top view showing each of tile models or tile models Z, Y, X, and J having 3different internal, top surface parts. Each of tile models or tile models Z, Y, X, and J has 3 different internal, top surface parts projecting inwards from the 3 outer curvature shapes A− and A+; B− and B+; and C− and C+ to 3 joined, adjacent pairs of internal sides having 3 internal curvature shapes that connect at an internal location LOC of each tile model.

Tile model or tile Z has 3 different internal, top surface parts AZ, BZ, and CZ projecting inwards from the 3 outer curvature shapes A− and A+; B− and B+; and C− and C+, respectively, to 3 joined, adjacent pairs of internal sides CAZ and BAZ; CBZ and BAZ; and CAZ and CBZ, respectively, having 3 internal curvature shapes. Internal sides CAZ, CBZ and BAZ connect at an internal location LOCZ, as shown.

Tile model or tile Y has 3 different internal, top surface parts AY, BY and CY projecting inwards from the 3 outer curvature shapes A− and A+; B− and B+; and C− and C+, respectively, to 3 joined, adjacent pairs of internal sides CAY and BAY; CBY and BAY; and CAY and CBY, respectively, having 3 internal curvature shapes. Internal sides CAY, CBY, and BAY connect at an internal location LOCY, as shown.

Tile model or tile X has 3 different internal, top surface parts AX, BX, and CX projecting inwards from the 3 outer curvature shapes A− and A+; B− and B+; and C− and C+, respectively, to 3 joined, adjacent pairs of internal sides CAX and BAX; CBX and BAX; and CAX and CBX, respectively, having 3 internal curvature shapes. Internal sides CAX, CBX, and BAX connect at an internal location LOCX, as shown.

Tile model or tile J has 3 different internal, top surface parts AJ, BJ, and CJ projecting inwards from the 3 outer curvature shapes A− and A+; B− and B+; and C− and C+, respectively, to 3 joined, adjacent pairs of internal sides CAJ and BAJ; CBJ and BAJ; and CAJ and CBJ, respectively, having 3 internal curvature shapes. Internal sides CAJ, CBJ, and BAJ connect at an internal location LOCJ, as shown.

The 3 different internal, top surface parts A, B, and C of each tile model may correspond to corners A, B, and C, where each surface part has a generally quadrilateral or diamond shape with 4 curved sides. Each surface part may have internal angles of roughly 60, 30, 60, and 30 degrees. The 3 different internal, top surface parts may be areas or divisions of the top surface corresponding to or at corners A, B, and C.

The shape (e.g., top surface area shape) of each of the 3 different internal surface parts of each of the tile models Z, Y, X, and J is different than each shape of the 3 different internal surface parts of each of the other of the tile models Z, Y, X, and J. The shape of each surface part A of a tile may be different than that of each surface part A of each of the other of the tile models Z, Y, X, and J. In some cases, the shape of each of the internal surface parts of each of the tile models Z, Y, X, and J is different than the shape of all of the internal surface parts of all of the other of the tile models Z, Y, X, and J. The shape of each surface part A, B, or C of any tile may be different than the shape of all surface parts A, B, and C of all of the tile models Z, Y, X, and J.

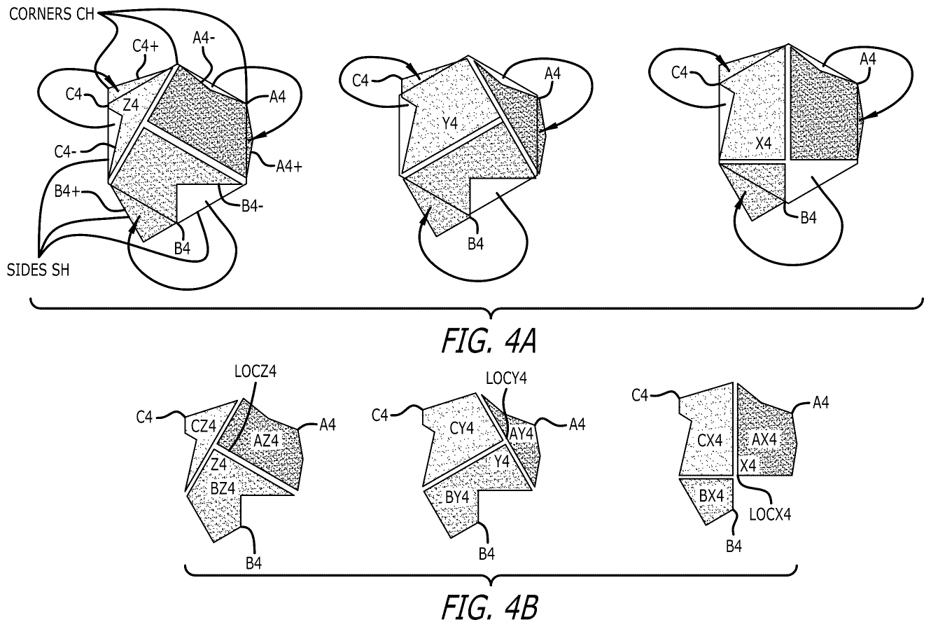

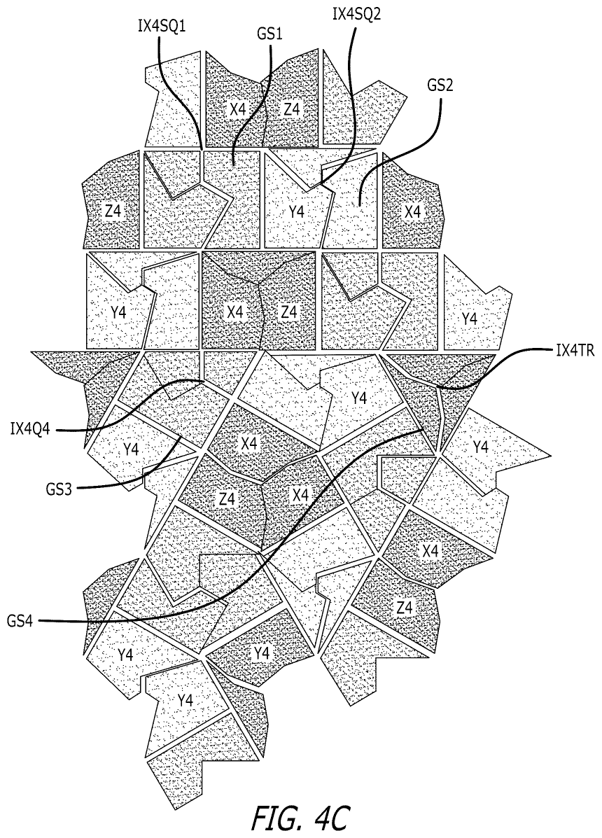

Combinations of the 3 corresponding internal surface parts of (e.g., AX, BX, or CX) at intersections of 3 tile models of the limited number of tile models are configured to create a top surface of the tile models with rarely repeating shapes, such as at the triangular intersections of an assembly ASSY of the limited number of tile models to tile models. Having generally hexagon shaped tile models with irregular or curved sides with only two pair compatible with each other of the 3 outer curvature shapes A− and A+; B− and B+; and C− and C+ (internal and external/positive negative perimeter shapes), it is consequently possible to divide the internal part or top surface area in a different way, dividing them into three shapes or surface parts A, B, and C, which are different internally as shown in FIG. 4. In addition, referring to the 3 outer curvature shapes A− and A+; B− and B+; and C− , and C+, each of the 3 different internal, top surface parts A, B and C (e.g., three defined single shapes) of each tile model can be sectioned at will into other styles or shapes; thus creating more tile models (e.g., by a multiple of 3 for each top surface part).

FIG. 1F is a top view showing each of tile models or tile models Z, Y, X, and J having 3 different sectioned styles. Each of tile models or tile models Z, Y, X, and J has the 3 different internal surface parts corresponding to corners A, B, and C having at least 3 different sectioned styles, such as shown. In this case, each section's style is 3 dividing lines creating 4 segments of each internal surface part. However, other numbers of dividing lines and segments are considered.

Tile model or tile Z has 3 different sectioned styles AZS, BZS, and CZS at, on, and/or in the 3 different internal, top surface parts AZ, BZ, and CZ, respectively. The 3 different sectioned styles AZS, BZS, and CZS may correspond to and radiate from corners A, B, and C, to each joined, adjacent pair of internal sides CAZ and BAZ; CBZ and BAZ; and CAZ and CBZ, respectively, as shown.

Tile model or tile Y has 3 different sectioned styles AYS, BYS, and CYS at, on, and/or in the 3 different internal, top surface parts AY, BY, and CY, respectively. The 3 different sectioned styles AYS, BYS, and CYS may correspond to and radiate from corners A, B, and C, to each joined, adjacent pair of internal sides CAY and BAY; CBY and BAY; and CAY and CBY, respectively, as shown.

Tile model or tile X has 3 different sectioned styles AXS, BXS, and CXS at, on, and/or in the 3 different internal, top surface parts AX, BX, and CX, respectively, as shown. The 3 different sectioned styles AXS, BXS, and CXS may correspond to and radiate from corners A, B, and C, to each joined, adjacent pair of internal sides CAX and BAX; CBX and BAX; and CAX and CBX, respectively, as shown.

Tile model or tile J has 3 different sectioned styles AJS, BJS, and CJS at, on, and/or in the 3 different internal, top surface parts AJ, BJ, and CJ, respectively, as shown. The 3 different sectioned styles AJS, BJS, and CJS may correspond to and radiate from corners A, B, and C, to each joined, adjacent pair of internal sides CAJ and BAJ; CBJ and BAJ; and CAJ and CBJ, respectively, as shown.

The 3 different sectioned styles may be or include 3 different areas (e.g., of the 3 different internal, top surface parts) each having different styles, segments, divisions, shapes, lines, textures, images (e.g., small images of stars, moons, birds, cats, rainbows, etc.) and/or grains. In some cases, the 3 different internal surface parts of the limited number of tile models are configured to form a floral bloom pattern at each of the intersections.

The sectioned style (e.g., style, shapes, lines, textures or grains) of each of the 3 different sectioned styles of each of the tile models Z, Y, X, and J is different than each sectioned style of the 3 different sectioned styles of each of the other of the tile models Z, Y, X, and J. The sectioned style of each surface part A of a tile may be different than that of each surface part A of each of the other of the tile models Z, Y, X, and J. In some cases, the sectioned style of each of the internal surface parts of each of the tile models Z, Y, X, and J is different than the sectioned style of all of the internal surface parts of all of the other of the tile models Z, Y, X, and J. The sectioned style of each surface part A, B, or C of any tile may be different than the sectioned style of all surface parts A, B, and C of all of the tile models Z, Y, X, and J.

Combinations of the 3 corresponding 3 different sectioned styles of (e.g., AXS, BXS, or CXS) at intersections of 3 tile models of the limited number of tile models are configured to create a top surface of the tile models with rarely repeating designs, such as at the triangular intersections of an assembly ASSY of the limited number of tile models to tile models. The three different shapes or internal surface parts defined on each irregular hexagon tile, having the same perimeter shapes (e.g., same pair of curved sides or outer curvature shape) can be better defined with the use of materials of different color, finish and or composition, such as shown in FIG. 1G.

FIG. 1G is a top view showing each of tile or tile models Z, Y, X, and J having 3 different colors. Each of tile models or tile models Z, Y, X, and J has the 3 different internal surface parts A, B, and C having at least 3 different colors, such as shown.

Tile model or tile Z has 3 different colors AZSC, BZSC and CZSC at, on, and/or in the 3 different internal, top surface parts AZ, BZ, and CZ, respectively. The 3 different colors AZSC, BZSC, and CZSC may correspond to and radiate from corners A, B, and C, to each joined, adjacent pair of internal sides CAZ and BAZ; CBZ and BAZ; and CAZ and CBZ, respectively, as shown.

Tile model or tile Y has 3 different colors AYSC, BYSC, and CYSC at, on, and/or in the 3 different internal, top surface parts AY, BY, and CY, respectively. The 3 different colors AYSC, BYSC, and CYSC may correspond to and radiate from corners A, B, and C, to each joined, adjacent pair of internal sides CAY and BAY; CBY and BAY; and CAY and CBY, respectively, as shown.

Tile model or tile X has 3 different colors AXSC, BXSC, and CXSC at, on, and/or in the 3 different internal, top surface parts AX, BX, and CX, respectively, as shown. The 3 different colors AXSC, BXSC, and CXSC may correspond to and radiate from corners A, B, and C, to each joined, adjacent pair of internal sides CAX and BAX; CBX and BAX; and CAX and CBX, respectively, as shown.

Tile model or tile Y has 3 different colors AJSC, BJSC, and CJSC at, on, and/or in the 3 different internal, top surface parts AJ, BJ, and CJ, respectively, as shown. The 3 different colors AJS, BJS, and CJS may correspond to and radiate from corners A, B, and C, to each joined, adjacent pair of internal sides CAJ and BAJ; CBJ and BAJ; and CAJ and CBJ, respectively, as shown.

The 3 different colors may be or include 3 different areas (e.g., of the 3 different internal, top surface parts) each having a different color, finish, composition, polish, shade, brightness, hue. In some cases, the 3 different colors of the limited number of tile models are configured to form a floral bloom pattern at each of the intersections.

The 3 different colors may be the same (e.g., not different than) as the 3 different colors of each of the other tile models, such as to form a design at each intersection having a same color design at each intersection. The color (e.g., color, finish, composition, polish, shade, brightness, hue) of each of the 3 different colors of each of the tile models Z, Y, X, and J may be the same as each color of the 3 different colors of each of the other of the tile models Z, Y, X, and J. The color of each surface part A, B, and C of a tile may be the same as that of each surface part A, B, and C, respectively, of each of the other of the ile models Z, Y, X and J. Combinations of the 3 corresponding colors of (e.g., AXSC, BXSC or CXSC) at intersections of 3 tile models of the limited number of tile models are configured to create a top surface of the tile models with rarely repeating designs, such as at the triangular intersections of an assembly ASSY of the limited number of tiles to tile models.

The limited number, such as of 4 tiles or tile models can be assembled, installed or laid randomly mixed where the same pairs of curved sides A− and A+; B− and B+; and C− and C+ of the 6 perimeter sides necessarily fit together to automatically create different shapes and/or designs at the intersections IX of each of 3 of the tile models, such as in FIG. 1H.

FIG. 1H shows a top view of a limited number of 4 tile models Z, Y, X, and J assembled into tile assembly ASSY that creates a surface S with rarely repeating designs and shapes at triangular intersections IX of the tile models. The apparent irregular shape of the 6 perimeter sides A−, A+, B−, B+, C−, and C+ provides a generally or irregular hexagon, which matches perfectly with the other identical ones, allowing a 120° rotation of each of the tile models compared to the previous one during installation to form assembly ASSY. Assembly ASSY may be or include tiles or tile models assembled into or that form a tile assembly or composition to create a surface S with rarely repeating (e.g., almost non-repetitive) designs and shapes at triangular intersections IX of the tile models.

Assembly ASSY of FIG. 1H may be assembly ASSY of FIG. 1D using or including a limited number of tile models, such as Z, Y, X, and J. These tile models have 6 sides divided into three pairs of sides or parts A, B, and C by curving them and making them opposite (e.g., female and male) to allow the laying of another tile model joined with the same curved side of the 6 perimeter sides so that they are joined at A− and A+; B− and B+, and C−, and C+ as shown. While assembly ASSY of FIG. 1D more clearly shows the pairs of perimeter sides of top surface S of the tile models, assembly ASSY of FIG. 1H more clearly shows the rarely repeating shapes and designs at the triangular intersections IX of top surface S of the tile models.

The male shaped side of a tile A+; B+, and C+ may fit with no gaps (or a gap of up to 1, 2 or 3 millimeters) into a corresponding female shaped side A−; B−, and C−, respectively of another tile, such as shown in FIG. 1H. The tile assembly ASSY has columns C1, C2, and C3 and rows R1, R2, and R3 of random order sequences of the tile models Z, Y, X, and J. Each tile model is surrounded by 6 other tile models, with the exception of edge tiles. The tiles may be glued, adhered, nailed, screwed, epoxy, magnetically or otherwise attached to a surface below them, such as at their bottom surface.

The sequences may include the triangular intersections or conjunctions between 3 tile models of the limited number of tile models with a first tile model at the first orientation angle, a second tile model rotated by 120 degrees (e.g., ⅓ rotation clockwise) as compared to the first orientation angle, and a third tile model rotated by 240 degrees (e.g., ⅔ rotation clockwise) as compared to the first orientation angle. Each intersection may have the same or corresponding ones of the 3 different internal surface parts of the first, second and third tile models; and/or the intersections may have a same color of the first, second and third tile models.

The random order sequences may be random orders of the limited number of tile models per each of a number of the limited number of tile models. In examples of the random order sequence of 4 tile models, there would be a random order of the four tiles for a first sequence of the 4 tile models, then another random order of the 4 tiles for a second sequence of the 4 tile models (e.g., tiles 5-8), etc., restricted to having each of the 4 tile models appear with each sequence of 4 of the tiles. In examples of the random order sequence of 4 tile models, there would be a random order of the four tile models for each 8 tiles in the sequence, etc., restricted to having each of the 4 tile models appear with each sequence of 8 of the tiles. In another case, there would be a continuing random order of the 4 tile models, not restricted to having each of the 4 tile models appear with a sequence of 4 of the tiles. The random order sequences can be one of “truly random” (generated from physical phenomena like radioactive decay), “pseudo-random” (generated by algorithms that appear random but are deterministic), or “quasi-random” (designed to evenly distribute points across a space, not truly random but useful for certain applications)-with the key distinction between them being how well they mimic true randomness and the methods used to generate them; “independent” and “identically distributed” (IID) sequences are also important concepts in the study of random sequences within probability theory.

The tile models may be adjacent to each other, touching, joined or attached to each other at corresponding male shaped sides and female shaped sides, such that no gaps are formed between the corresponding male shaped sides and female shaped sides, such as shown in FIG. 1H. Corresponding surface parts of the 3 different internal surface parts of each of the limited number tile models may be configured to create a surface with rarely repeating shapes at triangular intersections or conjunctions between 3 tile models of the limited number tile models with a first tile model such as tile model Z1 at the orientation angle OA, a second tile model Z2 rotated by 120 degrees (e.g., ⅓) of a total clockwise rotation as compared to the first orientation angle OA, a third tile model Y1 rotated by 240 degrees (e.g., ⅔) of a total clockwise rotation as compared to the first orientation angle of OA. In some cases, the sequence of tile models of assembly ASSY includes a first tile model, such as tile model Z1, Z2, or Y1, at the orientation angle OA and each tile model joined to the first tile model rotated by one of 120 degrees (e.g., ⅓) of a total clockwise rotation of OA; or 240 degrees (e.g., ⅔) of a total clockwise rotation of OA as compared to the orientation angle OA. For example, the tile models in row R1 are at orientation angle OA, the tile models in row R2 are rotated by 240 degrees clockwise from first orientation angle OA, and the tile models in row R3 are rotated by 120 degrees clockwise from first orientation angle OA.

Triangular intersections IX are shown where any 3 of the tile models meet. Intersections IX can be an intersection of, at and/or including three corners of three different tile models. The tile models do not need to be different models of tiles but have the same or corresponding ones of corners A, B, or C of the 3 outer curvature shapes joined at the intersection. For example, nearly non-repetitive tile shape SHA2 for outer curvature shapes, design DP2 for internal surface parts and design D2C for color at intersection IX2 has the 3 corners C of tile models Z, Y, and Y, such as shown in FIG. 1H. Also, nearly non-repetitive tile shape SHA3 for outer curvature shapes, design DP3 for internal surface parts and design DC3 for color at intersection IX3 has the 3 corners B of tile models Y, Y, and J, such as shown in FIG. 1H.

The fact that there are pairs of adjacent, opposite curved sides (e.g., perimeter outer curvature shapes) may cause each subsequent tile to be forced to be laid with a rotation of 120°, thus always modifying not only the shape of the assembly and/or intersections but also the laying rotation of the tile models in the assembly. This creates a surprising and nearly never-the-same visual effect of the assembly and/or intersections, such as shown in FIG. 1H. The result of a simple random installation of the multiple tile models creates the formation of nearly rarely repeating or nearly non-repetitive tile shapes and/or designs, including at the tile intersections. Using at least four models creates the probability or percentage of seeing shapes that are really rarely repeated, such as zero, once or twice in a 10 column by 10 row assembly, e.g., of 100 tiles. Using at least four models creates the probability or percentage of seeing designs that are really rarely repeated, such as zero, once or twice in a 10 column by 10 row assembly, e.g., of 100 tiles. The limited number of four tile models provides an aesthetic result that is exciting and appears to be a Taylor made or personalized project. This can now be represented with a simpler solution by producing only 3 to 7 standard tile models in series using those same models. This significantly lowers production and installation costs, and maintains a result with shapes, designs and aesthetics that nearly never repeat.

The descriptions herein are examples as other perimeter outer curvature shapes and/or internal top surface part shapes, such as geometric or abstract, can be applied using the same concept. The descriptions herein provide tile models, assemblies and assembly processes using negative/positive sides of each regular hexagon, perimeter shape, and also the consequent internal sections or parts that are unique and create unique assemblies, such as with rarely repeating shapes and/or designs.

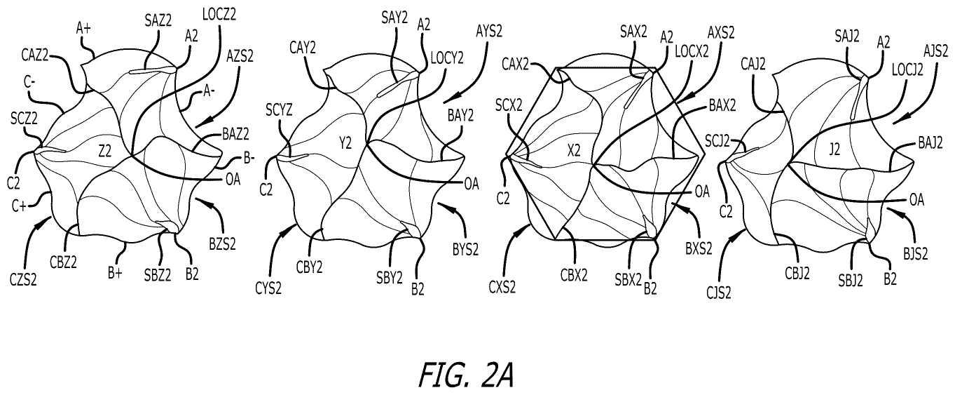

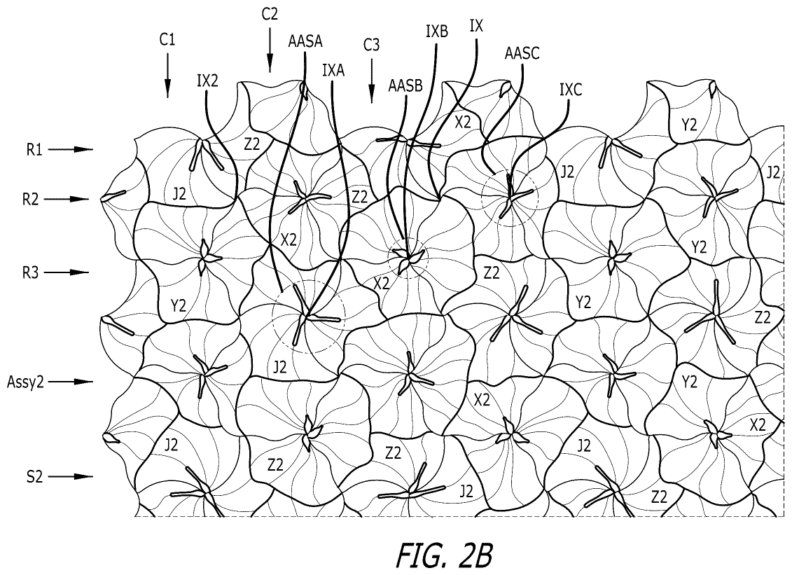

FIGS. 2A-2B describe a limited number of 4 tile models Z2, Y2, X2, and J2 that can be used to form tile assemblies or compositions that create a surface with rarely repeating designs and shapes at triangular intersections of the tile models, such as shown in FIG. 2B. FIG. 2A is a top view showing each of tile models or tile models Z2, Y2, X2, and J2 having 3 different sectioned styles. Each of tile models or tile models Z2, Y2, X2, and J2 has the 3 different internal surface parts corresponding to corners A2, B2, and C2 having at least 3 different sectioned styles, such as shown. In this case, each section's style is 3, 4, or 5 dividing lines creating 4, 5, or 6 segments of each internal surface part. However, other numbers of dividing lines and segments are considered.

Tile model or tile Z2 has 3 different sectioned styles AZS2, BZS2, and CZS2 at, on, and/or in the 3 different internal, top surface parts AZ2, BZ2, and CZ2, respectively. The 3 different sectioned styles AZS2, BZS2, and CZS2 may correspond to and radiate from corners A2, B2, and C2, to each joined, adjacent pair of internal sides CAZ2 and BAZ2; CBZ2 and BAZ2; and CAZ2 and CBZ2, respectively, as shown. Tile model or tile Z2 further include 3 different arm shaped splashes SAZ2, SBZ2, and SCZ2 extending inwards from the three corners A2, B2, and C2 towards internal location LOCZ2. These splashes are configured to form 3 armed accents AASA, AASB, and AASC at some of the intersections IXA, IXB, and IXC of first, second and third tile models, such as shown in FIG. 2B.

Tile model or tile Y2 has 3 different sectioned styles AYS2, BYS2, and CYS2 at, on, and/or in the 3 different internal, top surface parts AY2, BY2, and CY2, respectively. The 3 different sectioned styles AYS2, BYS2, and CYS2 may correspond to and radiate from corners A2, B2, and C2, to each joined, adjacent pair of internal sides CAY2 and BAY2; CBY2 and BAY2; and CAY2 and CBY2, respectively, as shown. Tile model or tile Y2 further include 3 different arm shaped splashes SAY2, SBY2, and SCY2 extending inwards from the three corners A2, B2, and C2 towards internal location LOCY2. These splashes are configured to form 3 armed accents AASA, AASB, and AASC at some of the intersections IXA, IXB, and IXC of first, second and third tile models, such as shown in FIG. 2B.

Tile model or tile X2 has 3 different sectioned styles AXS2, BXS2, and CXS2 at, on, and/or in the 3 different internal, top surface parts AX2, BX2, and CX2, respectively. The 3 different sectioned styles AXS2, BXS2, and CXS2 may correspond to and radiate from corners A2, B2, and C2, to each joined, adjacent pair of internal sides CAX2, and BAX2; CBX2 and BAX2; and CAX2 and CBX2, respectively, as shown. Tile model or tile X2 further include 3 different arm shaped splashes SAX2, SBX2, and SCX2 extending inwards from the three corners A2, B2, and C2 towards internal location LOCX2. These splashes are configured to form 3 armed accents AASA, AASB, and AASC at some of the intersections IXA, IXB, and IXC of first, second and third tile models, such as shown in FIG. 2B.

Tile model or tile J2 has 3 different sectioned styles AJS2, BJS2, and CJS2 at, on, and/or in the 3 different internal, top surface parts AJ2, BJ2, and CJ2, respectively. The 3 different sectioned styles AJS2, BJS2, and CJS2 may correspond to and radiate from corners A2, B2, and C2, to each joined, adjacent pair of internal sides CAJ2 and BAJ2; CBJ2 and BAJ2; and CAJ2 and CBJ2, respectively, as shown. Tile model or tile J2 further include 3 different arm shaped splashes SAJ2, SBJ2, and SCJ2 extending inwards from the three corners A2, B2, and C2 towards internal location LOCJ2. These splashes are configured to form 3 armed accents AASA, AASB, and AASC at some of the intersections IXA, IXB, and IXC of first, second and third tile models, such as shown in FIG. 2B. Intersections IX2 of first, second and third tile models do not have the arms, such as shown in FIG. 2B.

The 3 different sectioned styles of FIG. 2A may be or include 3 different areas (e.g., of the 3 different internal, top surface parts) each having different styles, segments, divisions, shapes, lines, textures and/or grains. The styles of FIG. 2A may be different than those in FIG. 1F. The 3 outer curvature shapes, internal surface parts, 3 internal curvature shapes and internal locations of each tile model of FIG. 2A may be different than those in FIGS. 1B-H. The sectioned style (e.g., style, shapes, lines, textures or grains) of each of the 3 different sectioned styles of each of the tile models Z2, Y2, X2, and J2 may be different than each sectioned style of the 3 different sectioned styles of each or all of the other of the tile models Z2, Y2, X2, and J2, such as noted for the sectioned styles of FIG. 1F. The 3 different arm shaped splashes may be or include 3 different areas (e.g., of the 3 different internal, top surface parts) each having a different splash, leaf, vein, flame, flare and or finger shape. The 3 different arm shaped splashes may or may not be between each of the 3 outer curvature shapes of each tile model.

Combinations of 3 corresponding ones of the 3 different arm shaped splashes of (e.g., at corners A2, B2, and C2) at intersections of 3 tile models of the limited number of tile models are configured to create a top surface of the tile models with rarely repeating designs, such as at the triangular intersections of an assembly ASSY2 of the limited number of tiles of tile models.

The 3 different arm shaped splashes may have 3 different widths and 3 different lengths. The 3 different arm shaped splashes may thin toward and end before the tile center or locations LOCZ2, COZY2 LOCX2 LOCJ2. In some cases, each of the 3 different arm shaped splashes have a different style splash such as a thinner width and longer length splash style for corners A; a thicker width and shorter length splash style for corners B; and a medium width and medium length splash style for corners C. In some cases, these styles can be interchanged as long as the same splash style is at the corresponding corner A, B, or C. In other cases, they need not be at corresponding corners. Each corresponding different arm shaped splash SA, SB, and SC of the 3 different arm shaped splashes may have the same style splash, color (e.g., see FIG. 1G), texture, shade and/or shine, such as to form a design at each of their intersections having the same arm shaped splashes or style splashes.

The different arm shaped splash (e.g., splash, color, finish, composition, polish, shade, brightness, hue) of each of the 3 different arm shaped splashes of each of the tile models Z2, Y2, X2, and J2 may be the same as each arm shaped splash of the 3 different arm shaped splashes of each of the other of the tile models Z2, Y2, X2, and J2. The arm shaped splash of each corner A2, B2, and C2 of a tile may be the same as that of each corner A2, B2, and C2, respectively, of each of the other of the tile models Z2, Y2, X2, and J2. In some cases, the 3 different internal surface parts of the limited number of tile models of FIG. 2A are configured to form a floral bloom pattern at each of the intersections of an assembly, such as assembly ASSY2 of FIG. 2B; and the 3 armed accents are configured to form a floral central pistil pattern in some of the floral bloom patterns of that assembly.

In some cases, tile models Z2, Y2, X2, and J2 further include colors as noted for FIG. 1G. In this case, the splashes may have or be a fourth color as compared to those of FIG. 1G.

The limited number, such as of 4 tile models or tile models of FIG. 2A can be assembled, installed or laid randomly mixed where the same 3 joined pairs of the 6 perimeter sides) having 3 outer curvature shapes (e.g., see A− and A+; B− and B+; and C− and C+ of the 6 perimeter sides of FIGS. 1B-1C and 1H) at corners A2, B2, an C2 necessarily fit together to automatically create different shapes and/or designs at the intersections IX of each of 3 of the tile models, such as in FIG. 2B.

FIG. 2B shows a top view of a limited number of 4 tile models Z2, Y2, X2, and J2 assembled into tile assembly ASSY2 that creates a surface S2 with rarely repeating designs and shapes at triangular intersections IX of the tile models. The apparent irregular shape of the 3 outer curvature shapes at corners A2, B2, an C2, such of the 6 perimeter sides (e.g., see sides A−, A+, B−, B+, C− and C+ of FIGS. 1B-C and 1H) provides a generally or irregular hexagon, which matches perfectly with the other identical ones, allowing a 120° rotation of each of the tile models compared to the previous one during installation to form assembly ASSY2. Assembly ASSY2 may be or include tiles or tile models assembled into or that form a tile assembly or composition to create a surface S2 with rarely repeating (e.g., almost non-repetitive) designs and shapes at triangular intersections IX of the tile models.

Assembly ASSY2 of FIG. 2B may be similar to assembly ASSY of FIG. 1H using or including a limited number of tile models, such as Z2, Y2, X2, and J2 in place of tile models Z, Y, X, and J. These tile models have 6 sides divided into three pairs of sides or parts A, B, and C by curving them and making them opposite (e.g., female and male) to allow the laying of another tile model joined with the same curved side of the 6 perimeter sides so that they are joined at A− and A+; B− and B+, and C− and C+ as shown. While assembly ASSY of FIG. 1H more clearly shows the color designs at the intersections IX, assembly ASSY2 of FIG. 2B more clearly shows the rarely repeating shapes and designs at the triangular intersections IX of top surface S of the tile models Z2, Y2, X2, and J2, such as including the arms and pistils.

The gaps, rows, columns, random order of sequences of tile models, adjacent to each other, intersections and/or rotations of tile models Z2, Y2, X2, and J2 of assembly ASSY2 of FIG. 2B may be the same as those of tile models Z, Y, X, and J of assembly ASSY of FIG. 1D and/or FIG. 1H.

Assembly ASSY2 is or includes the limited number of tile models Z2, Y2, X2, and J2 having 3 different arm shaped splashes (e.g., SAZ2, SBZ2 and SCZ2) extending inwards from the three corners A2, B2, and C2 between each of the 3 outer curvature shapes (e.g., AZ2, BZ2, and CZ2) that form 3 armed accents AASA, AASB, and AASC at intersections IXA, IXB, and IXC of the first, second and third tile models, such as shown in FIG. 2B.

Tile models Z2, Y2, X2, and J2 and/or ASSY2 shows that each flower having the 3 different internal surface parts of 3 tile models at each intersection changes to be each bloom that is a rarely repeating shape (and rotation with respect to orientation OA); and that the central pistol (of each flower) of the 3 different arm shaped splashes of 3 tile models at each intersection changes to be each pistil that is a rarely repeating design (and optionally rotation with respect to orientation OA). These rarely repeating shapes and designs makes the tile models and assemblies even more unique, and continually change to give a final aesthetic affect, of a very accurate and luxurious custom made tile assembly design.

The descriptions herein also apply to examples with only 1 or 2 perimeter outer curvature shapes and internal top surface part shapes that can be applied using the same concepts as above. These only 1 or 2 shapes and parts provide tile models, assemblies and assembly processes using 1 or 2 shapes and parts of negative/positive sides of each regular hexagon, perimeter shape, and also the consequent internal sections or parts that are unique and create unique assemblies, such as with rarely repeating shapes and/or designs.

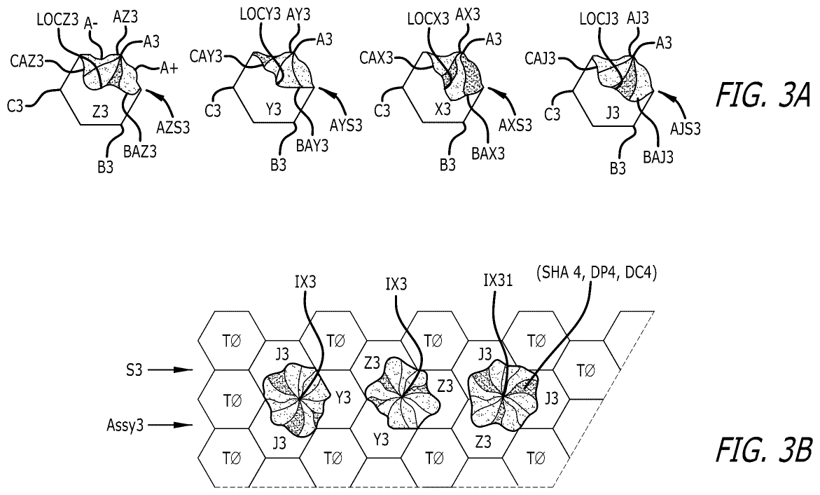

FIGS. 3A-3B describe a limited number of 4 tile models Z3, Y3, X3, and J3 with only 1 perimeter outer curvature shapes and only 1 internal top surface part shape that can be used to form tile assemblies or compositions that create a surface with rarely repeating designs and shapes at triangular intersections of the tile models, such as shown in FIG. 3B. FIG. 3A is a top view showing each of tile models or tile models Z3, Y3, X3, and J3 having 1 different sectioned style. Each of tile models or tile models Z3, Y3, X3, and J3 has the 1 different internal surface part corresponding to corner A3, but not any corresponding to corners B3 and C3; and having at only 1 corresponding different sectioned style, such as shown. In this case, each section's style is 3 dividing lines creating 4 segments of each internal surface part. However, other numbers of dividing lines and segments are considered.

Tile model or tile Z3 has 1 different sectioned style AZS3 at, on, and/or in the 1 different internal, top surface part AZ3. The different sectioned style AZS3 may correspond to and radiate from corner A3 to each joined, adjacent pair of internal sides CAZ3 and BAZ3, as shown.

Tile model or tile Y3 has 1 different sectioned style AYS3 at, on, and/or in the 1 different internal, top surface part AY3. The different sectioned style AYS3 may correspond to and radiate from corner A3 to each joined, adjacent pair of internal sides CAY3 and BAY3, as shown.

Tile model or tile X3 has 1 different sectioned style AXS3 at, on, and/or in the 1 different internal, top surface part AX3. The different sectioned style AXS3 may correspond to and radiate from corner A3 to each joined, adjacent pair of internal sides CAX3 and BAX3, as shown.

Tile model or tile J3 has 1 different sectioned style AJS3 at, on, and/or in the 1 different internal, top surface part AJ3. The different sectioned style AJS3 may correspond to and radiate from corner A3 to each joined, adjacent pair of internal sides CAJ3 and BAJ3, as shown.

Each of sectioned style AZS3, AYS3, AXS3, and AJS3 has outer curvature shapes A− and A+ when each tile model is at a first orientation angle OA.

FIG. 3A also shows each internal, top surface part AZS3, AYS3, AXS3, and AJS3 having 3 different colors at, on, and/or in the 3 different internal, top surface parts AZ3, AY3, AX3,and AJ3 respectively. The 3 different colors radiate from corners A3 to each joined, adjacent pair of internal sides CA and BA, as shown. The 3 different colors may be in a random sequence. In some cases, the colors are colors as noted for FIG. 1G. In some cases, each internal, top surface part AZS3, AYS3, AXS3, and AJS3 has a splash as noted for FIGS. 2A-2B.

Each of the 1 different internal, top surface part and/or sectioned style projects inwards from the 1 outer curvature shapes A− and A+ of corner A3 to 1 joined pair of internal sides (e.g., CAZ3 and BAZ3) having 1 internal curvature shape that connect at an internal locations LOCZ3, LOCY3, LOCX3, and LOCJ3, respectively.

Each joined, adjacent pair of internal sides of tile models Z3, Y3, X3, and J3 is different than that of the internal sides of all of the other tile models Z3, Y3, X3, and J3. In some cases, the sectioned style of each of the tile models Z3, Y3, X3, and J3 is different than the sectioned style of all of other tile models Z, Y, X, and J.

Combinations of the 1 different internal, top surface part, and/or sectioned style and/or colors at intersections of 3 tile models of the limited number of tile models are configured to create a top surface S3 of the tile models with rarely repeating designs, such as at the triangular intersections of an assembly ASSY3 of the limited number of tiles of tile models.

The limited number, such as of 4 tiles or tile models of FIG. 3A can be assembled, installed or laid randomly mixed where the same 3 joined pairs having 3 outer curvature shapes (e.g., see A− and A+; B− and B+; and C− and C+ of the 6 perimeter sides of FIGS. 1B-1C and 1H) at corners A2, B2, an C2 necessarily fit together to automatically create different shapes and/or designs at the intersections IX of each of 3 of the tile models, such as in FIG. 3B.

FIG. 3B shows a top view of a limited number of 4 tile models Z3, Y3, X3, and J3 assembled into tile assembly ASSY3 that creates a surface S3 with rarely repeating designs and shapes at triangular intersections IX3 of these tile models. FIG. 3B shows hexagonal tiles T0 intermixed randomly with but not at intersections IX3 of the assembled limited number of 4 tile models Z3, Y3, X3, and J3. In some cases, each section's style includes 3 or 4 dividing lines creating 4 or 5 segments of each internal surface part; and the 3 different internal surface parts of the limited number of tile models are configured to form a floral bloom pattern at each of the intersections.

In some cases, the 3 different colors of each tile model are the same colors as the 3 different colors of each of the 1 different internal surface parts of the other limited number of tile models. In some cases, the 3 different colors of each of the limited number of tile models are configured to create the surface with the rarely repeating designs at the triangular intersections IX3. In some cases, the 3 different colors are randomly selected for each of the tile models. In some cases, the 3 different colors of the limited number of tile models are configured to form a floral bloom pattern at each of the intersections. For example, nearly non-repetitive tile shape SHA4 for outer curvature shapes, design DP4 for internal surface parts and design DC4 for color at intersection IX31 has the 3 corners A of tile models J3, J3, and Z3, such as shown in FIG. 3B.

The apparent irregular shape of the 3 outer curvature shapes at corner A3, such of the 6 perimeter sides (e.g., see sides A−, A+ of FIG. 2A) provides a general or irregular hexagon, which matches perfectly with the other identical ones, allowing a 120° rotation of each of the tile models compared to the previous one during installation to form assembly ASSY3. Assembly ASSY3 may be or include tile models or tile models assembled into or that form a tile assembly or composition to create a surface S3 with rarely repeating (e.g., almost non-repetitive) designs and shapes at triangular intersections IX3 of these tile models.

Assembly ASSY3 of FIG. 3B may be similar to assembly ASSY of FIG. 1H, but using or including a limited number of tile models T0, Z3, Y3, X3, and J3 instead of tile models Z, Y, X, and J. The gaps, rows, columns, random order of sequences of tile models, adjacent to each other, intersections and/or rotations of tiles T0, Z3, Y3, X3, and J3 of assembly ASSY3 of FIG. 3B may be the same as those of tiles of assembly ASSY of FIG. 1H.

Tile models Z3, Y3, X3, and J3 and/or ASSY3 shows that each flower having the 1 different internal surface parts of 3 tile models at each intersection changes to be each bloom that is a rarely repeating shape (and rotation with respect to orientation OA) and a rarely repeating design. These rarely repeating shapes and designs makes the tile models and assemblies unique, and continually change to give a final aesthetic affect, of a very accurate and luxurious custom made tile assembly design. As a result, it is, possible to create a personalized design without unreasonable costs.

As noted, the concepts above also apply to embodiments with fewer than 4 tile models or tile models. In addition, the concepts above can be applied to geometric shapes such as angled linear segments.

FIGS. 4A-4H describe a limited number of 3 tile models Z4, Y4, and X4 that can be used to form tile assemblies or compositions that create a surface with rarely repeating shapes and geometric designs at triangular intersections of the tile models, such as shown in FIG. 4C. Each of 3 tile models Z4, Y4, and X4 is configured to form an assembly ASSY4 with a surface S4 having rarely repeating shapes and geometric designs at intersections by using angled shapes of linear segments. FIG. 4A shows a top view of a limited number of 3 tile models Z4, Y4, and X4 each having 6 perimeter side shapes A4−, A4+, B4−, B4+, C4− and C4+ overlaid over sides SH between the 6 corners. The 6 perimeter side shapes are 3 joined or adjacent pairs A4−+, B4−+, and C4−+ of the sides having 3 outer angled shapes A4− and A4+; B4− and B4+; and C4− and C4+ of linear segments when each tile model is at a first orientation angle OA. The angled shapes may be between 2 and 6 linear segments forming angles at each of their intersections. In the example of FIGS. 4A-C, there are 4 linear segments forming 3 different angles between each of their intersections.

FIG. 4A shows 3 arrows where each of the 3 outer angled shapes includes a female (e.g., negative or internal) shaped side A4−, B4− and C4− having a first area removed to form a female shaped side from side SH and an adjacent male (e.g., positive or external) shaped side A4+, B4+ and C4+ having the corresponding first area added to it to form the male shaped side from side SH.

FIG. 4B shows a top view of a limited number of 3 tile models Z4, Y4, and X4 each having a top surface (shown), a bottom surface (not shown) and the perimeter P of 6 perimeter sides A4−, A4+, B4−, B4+, C4− and C4+ between the 6 corners. The 6 perimeter sides form a generally 6 sided, hexagonal shape with 3 joined or adjacent pairs A4−+, B4−+ and C4−+ of the sides having 3 outer angled shapes A4− and A4+; B4− and B4+; and C4− and C4+ of linear segments when each tile model is at a first orientation angle OA. The corresponding 2 sides of 3 adjacent pairs connect or have tile lateral junctions at corners A4, B4, and C4 as shown. Each of tile models Z4, Y4, and X4 may be a tile model as they are not only individual tiles but multiple ones of them can be used in a set of 3 model of tiles that are used, assembled or installed to form tile assemblies ASSY4 and the like.

The male shaped side of each of tile models Z4, Y4, and X4 fits with no gaps into a corresponding female shaped side of another of each of tile models Z4, Y4, and X4. Each of tile models Z4, Y4, and X4 has 3 different corresponding ones of internal top surface parts (e.g., AZ4, BZ4 and CZ4) projecting inwards from the 3 outer angled shapes A4− and A4+; B4− and B4+; and C4− and C4+ to 3 single or joined pairs of internal sides having 3 internal angled linear segments that connect at an internal location LOCZ4, LOCY4, and LOCX4 of each tile model. Each of the 3 different internal surface parts (e.g., AZ4, BZ4, and CZ4) of each of the limited number of tile models Z4, Y4, and X4 are different than each of the 3 different internal surface parts of each of the other of the limited number of tile models Z4, Y4, and X4. Corresponding surface parts of the 3 different internal surface parts of each of the limited number tile models Z4, Y4, and X4 are configured to create a surface S4 with rarely repeating shapes at triangular intersections IX4 between 3 tile models of the limited number tile models Z4, Y4, and X4 with a first tile model at the first orientation angle OA, a second tile model rotated by 120 degrees as compared to the first orientation angle OA, and a third tile model rotated by 240 degrees as compared to the first orientation angle OA. The limited number, such as of 3 tile models or tile models can be assembled, installed or laid randomly mixed where the same joined pairs of angled sides A4− and A4+; B4− and B4+; and C4− and C4+ of the 6 perimeter sides necessarily fit together to automatically create different shapes and/or designs at the intersections IX4 of each of 3 of the tile models, such as in FIG. 4C.

FIG. 4C shows a top view of a limited number of 3 tile models Z4, Y4, and X4 assembled into tile assembly ASSY4 that creates a surface S4 with rarely repeating designs and shapes at triangular intersections IX4 of the tile models. The apparent irregular shape of the 6 perimeter sides A4−, A4+, B4−, B4+, C4−, and C4+ provides a generally or irregular hexagon, which matches perfectly with the other identical ones, allowing a 120°rotation of each of the 3tile models compared to the previous one during installation to form assembly ASSY4. Assembly ASSY4 may be or include tiles or tile models assembled into or that form a tile assembly or composition to create a surface S4 with rarely repeating (e.g., almost non-repetitive) designs and shapes at triangular intersections IX4 of the tile models.

Assembly ASSY4 of FIG. 4C may be similar to assembly ASSY of FIG. 1H, but using or including a limited number of tile models Z4, Y4, and X4 instead of tile models Z, Y, X, and J. The gaps, rows, columns, random order of sequences of tile models, adjacent to each other, intersections and/or rotations of tile models Z4, Y4, and X4 of assembly ASSY4 of FIG. 4C may be the same as those of tile models of assembly ASSY of FIG. 1H.

In some cases, the 3 different colors of each tile model Z4, Y4 and X4 are the same colors as the 3 different colors of other tile models of Z4, Y4, and X4. In some cases, the 3 different colors of each of the limited number of tile models Z4, Y4, and X4 are configured to create the surface with the rarely repeating designs at the triangular intersections IX4. Each of 3 tile models Z4, Y4, and X4 is configured to form an assembly ASSY4 with a surface S4 having rarely repeating angled shapes at intersections IX4 using joined pairs of angled sides A4− and A4+; B4− and B4+; and C4− and C4+ of linear segments at each of intersections IX4 of 3 tile models Z4, Y4, and X4. Each of 3 tile models Z4, Y4, and X4 is configured to form an assembly ASSY4 with a surface S4 having rarely repeating geometric designs by using 3 different corresponding ones of internal top surface parts (e.g., AZ4, AY4, and AX4) at each of intersections IX4 of 3 tile models Z4, Y4, and X4. Each of 3 tile models Z4, Y4, and X4 is configured to form an assembly ASSY4 with a surface S4 having rarely repeating geometric designs by using 3 different corresponding colors of internal top surface parts (e.g., AZ4, AY4, and AX4) at each of intersections IX4 of 3 tile models Z4, Y4, and X4. Each of the limited number of tile models Z4, Y4, and X4 may be configured to form an assembly ASSY4 with a surface S4 having rarely repeating geometric designs by using the 3 different corresponding colors of internal top surface parts at the intersections. Each geometric designs may be a square, triangle, rectangle, quadrilateral, or other linear sided shape, such as shown by geometric design square shape GS1 at intersection IX4SQ1, geometric design square shape GS2 at intersection IX4SQ2, geometric design quadrilateral shape GS3 at intersection IX4SQ3, and geometric design triangle shape GS3 at intersection IX4SQ3.

As noted, the concepts above also apply to embodiments with more than 4 tile models or tile models. For example, tile models Z, Y, X, and J of FIGS. 1A-1H can be expanded by adding tile models K and W to FIGS. 1A-1H.

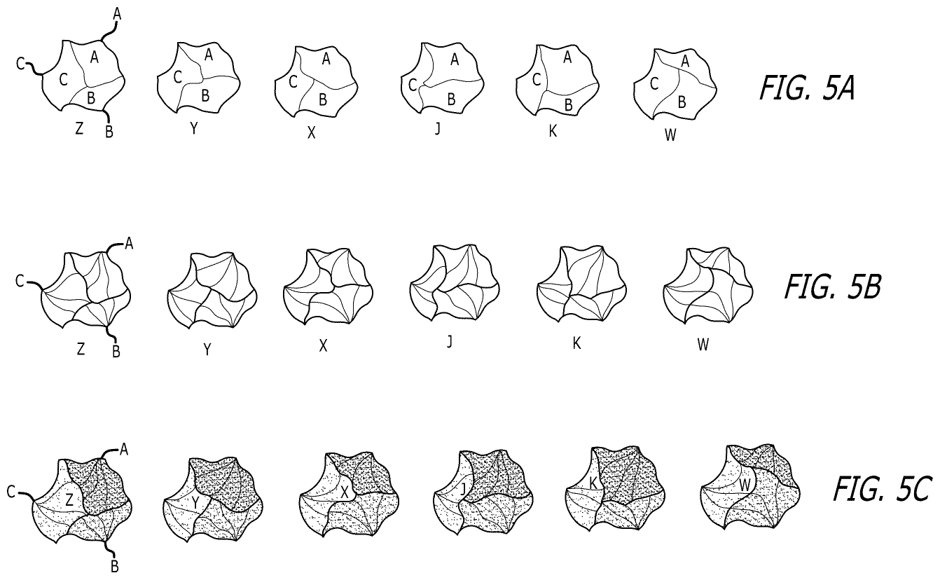

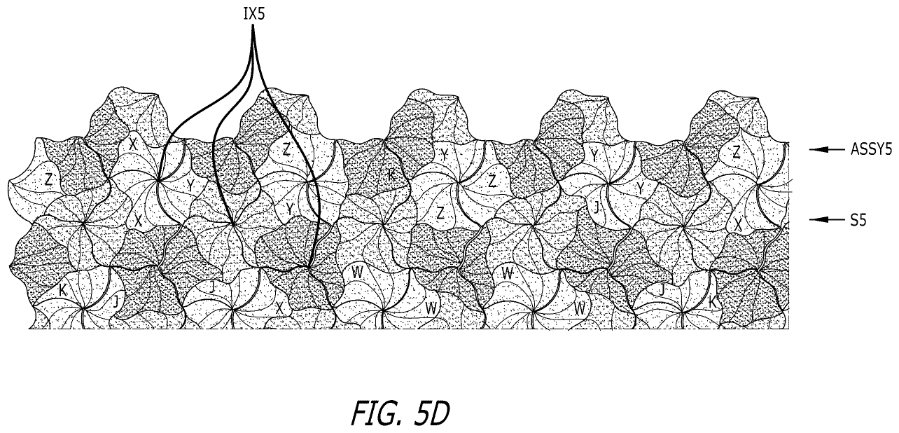

FIGS. 5A-5D describe a limited number of 6 tile models Z, Y, X, J, K, and W that can be used to form tile assemblies or compositions that create a surface with rarely repeating designs and shapes at triangular intersections of the tile models, such as shown in FIG. 5D. For example, tile models Z, Y, X, and J can be appended by adding tile models K and W to FIGS. 1A-1H.

FIG. 5A shows a top view of a limited number of 6 tile models Z, Y, X, J, K, and W each having a top surface (shown), a bottom surface (not shown) and the perimeter P of 6 perimeter sides A−, A+, B−, B+, C−, and C+ between the 6 corners CH. The 6 perimeter sides form a generally 6 sided, hexagonal shape with 3 joined or adjacent pairs A−+, B−+, and C−+ of the sides having 3 outer curvature shapes A− and A+; B− and B+; and C− and C+ when each tile model is at a first orientation angle OA, such as noted for tile models Z, Y, X, and J of FIGS. 1A-1D. The corresponding 2 sides of 3 adjacent pairs connect or have tile lateral junctions at corners A, B, and C as shown. Each of tile models Z, Y, X, J, K, and W may be a tile model as they are not only individual tile models but multiple ones of them can be used in a set of 6 models that are used, assembled or installed to form tile assemblies ASSY5 and the like. FIG. 5A shows each of 6 tile models Z, Y, X, J, K, and W having 3 different internal, top surface parts projecting inwards from the 3 outer curvature shapes such has shapes A− and A+; B− and B+; and C− and C+ to 3 joined, adjacent pairs of internal sides having 3 internal curvature shapes that connect at an internal location LOC of each tile model, such as noted for tile models Z, Y, X, and J of FIGS. 1A-1D.

FIG. 5B is a top view showing each of tile models or tiles Z, Y, X, J, K, and W having 3 different sectioned styles. Each of tile models or tile models Z, Y, X, J, K, and W has the 3 different internal surface parts corresponding to corners A, B, and C having at least 3 different sectioned styles, such as noted for tile models Z, Y, X, and J of FIGS. 1A-1D. In this case, each section's style is 3 dividing lines creating 4 segments of each internal surface part. However, other numbers of dividing lines and segments are considered.

FIG. 5C is a top view showing each of tile models or tiles Z, Y, X, J, K, and W having 3 different colors in each internal, top surface part. Each of tile models or tiles Z, Y, X, J, K, and W has the 3 different colors corresponding to corners A, B, and C, such as noted for 3 different colors of tile models Z, Y, X, and J of FIGS. 1A-1D.

The limited number, such as of 6 tiles or tile models can be assembled, installed or laid randomly mixed where the same pairs of curved sides A− and A+; B− and B+; and C− and C+ of the 6 perimeter sides necessarily fit together to automatically create different shapes and/or designs at the intersections IX5 of each of 3 of the tile models, such as in FIG. 5D.

FIG. 5D shows a top view of a limited number of 6 tile models Z, Y, X, J, K, and W assembled into tile assembly ASSY5 that creates a surface S5 with rarely repeating designs and shapes at triangular intersections IX5 of the tile models, such as noted for ASSY that creates a surface S with rarely repeating designs and shapes at triangular intersections IX of tile models Z, Y, X, and J of FIGS. 1A-1D.

Instead of having a flat homogeneous thickness of all of the limited number of tile models, there is an option to produce three different thickness, always obtaining changes of shape and thickness together with more distinctive aesthetic results than simple flat surface tile models. Thus, the concepts above also apply to embodiments with different tile thicknesses THA, THB, and THC (e.g., between the top and bottom surfaces) in the 3 different internal surface parts (e.g., AZ, BZ, and CZ, respectively) of the limited number of tile models.

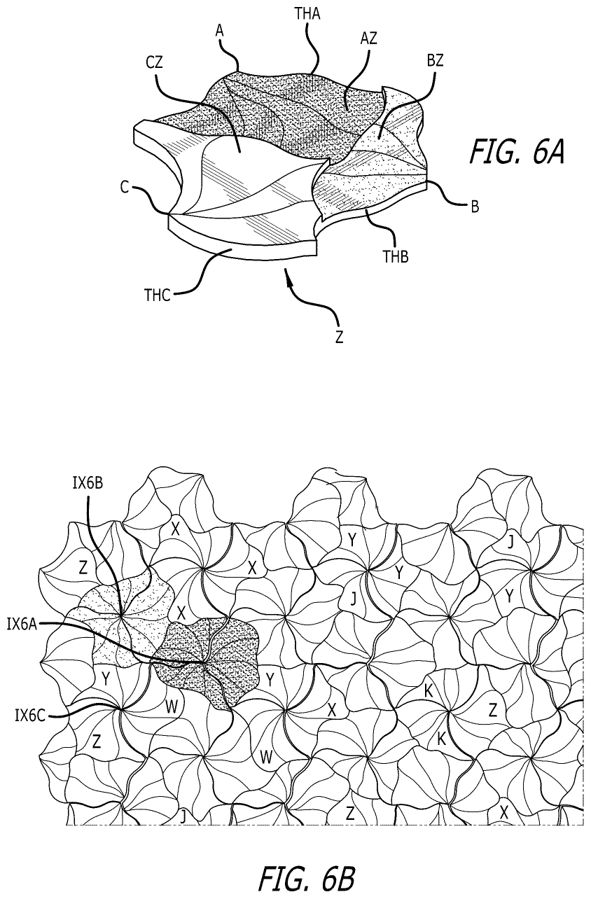

FIGS. 6A-6B describe a limited number of 6 tile models Z, Y, X, J, K, and W having different thicknesses that can be used to form tile assemblies or compositions that create a surface with rarely repeating tile thickness designs and shapes at triangular intersections of the tile models, such as shown in FIG. 6B. For example, tile models Z, Y, X, and J can be appended by adding tile models K and W to FIGS. 1A-1H. The thickness concepts of FIG. 6A for tile model Z can be expanded to any 1 or more internal surface parts (e.g., AZ, BZ, and CZ, respectively) of the limited number of tile models herein. For example, a different thickness THA, THB, and THC can be applied to each of parts A, B, and C (respectively) of 3, 4, 5, 6, or 7 tile models. A different thickness THA, THB, and THC can be applied to only part A, B or C of 3, 4, 5, 6, or 7 tile models. The bottom surface of each tile may be flat and the thicknesses THA, THB, and THC vary the height of the 3 parts A, B, and C of each tile. The top surfaces of the part may be curved at or near the borders between each of the 3 parts so as not to have edges between the parts. In other cases, the top surface of each part is flat and there are edges between the parts based on the different thicknesses. In some cases, thickness THA is less than thickness THB which is less than thickness THC.

FIG. 6A shows a top perspective view of tile model Z of a limited number of 6 tile models Z, Y, X, J, K, and W each having a top surface (shown), a bottom surface (not shown) and 3 joined or adjacent pairs A−+, B−+, and C−+ of the sides having 3 outer curvature shapes A− and A+; B− and B+; and C− and C+ when each tile model is at a first orientation angle OA. Tile model Z has a thickness THA, THB, and THC (e.g., between the top and bottom surfaces) in the 3 different internal surface parts AZ, BZ, and CZ, respectively. This concept can be expanded to any number of internal surface parts. This concept can be expanded to any number tile models of a limited number of tile models. Thickness THA, THB, and THC are the same for each of 3 tile models at each intersection (e.g., IX, IXA, IX3, IX4, IX5, etc.).

Each of the 3 different internal surface parts AZ, BZ, and CZ of tile model Z have a different thickness THA, THB, and THC, respectively. In this case thickness THA is less than thickness THB which is less than thickness THC. However, the differences in thickness may vary between parts AZ, BZ, and CZ. This concept applies to any or all parts AZ, BZ, and CZ, for any or all of a limited number of tile models. Each intersection of 3 tile models has a same thickness of the 3 different internal surface parts of the first, second and third tile models. The limited number, such as of 6 tile models or tile models having thickness THA, THB, and THC can be assembled, installed or laid randomly mixed where the same pairs of curved sides A− and A+; B− and B+; and C− and C+ of the 6 perimeter sides necessarily fit together to automatically create different shapes and/or designs at the intersections IX6A, IX6B, and IX6C of each of 3 of the tile models, such as in FIG. 6B.

FIG. 6B shows a top view of a limited number of 6 tile models Z, Y, X, J, K, and W assembled into tile assembly ASSY6 that creates a surface S6 with rarely repeating designs and shapes at triangular intersections IX6A, IX6B, and IX6C of the tile models, such as noted for ASSY that creates a surface S with rarely repeating designs and shapes at triangular intersections IX of tile models Z, Y, X, and J of FIGS. 1A-1D. Each of intersections IX6A, IX6B, and IX6C has a different thickness THA, THB, and THC, respectively.

In some cases, each of thickness THA, THB, and THC exist through the entire surface of each of the 3 different internal surface parts AZ, BZ, and CZ. That is, location LOCZ, LOCY, LOCX, and LOCJ may have each of thickness THA, THB, and THC. In some cases, each of thickness THA, THB, and THC taper to a location LOC thickness (e.g., which can by any one of thickness THA, THB, or THC) from the 6 perimeter sides to the location LOC of each tile model. That is, location LOCZ, LOCY, LOCX, and LOCJ may have a same thickness that is one of thickness THA, THB, or THC.

Combinations of the 3 corresponding thickness THA, THB, and THC at intersections of 3 (e.g., tiles of/or) tile models of the limited number of tile models are configured to create a top surface of the tile models with rarely repeating designs, such as at the triangular intersections of an assembly ASSY6 of the limited number of tiles of tile models. In this case, the rarely repeating design is or is added to by different intersections having different thickness THA, THB, and THC. Corresponding thickness of the same 3 thickness of each of the limited number of tile models may be configured to create the surface with the rarely repeating designs at the triangular intersections. In some cases, the intersection of three tiles having different thickness has a same thickness. In some cases, the center of each tile model has a same thickness, such as where the different thicknesses are at the perimeter shapes of the tiles and are reduced to a single thickness at the center of the tiles.

Embodiments herein include a tile composition including (e.g., assembly of tiles of) a limited number of between 4 and 6 tile models each having a top surface, a bottom surface and a hexagon located perimeter corners with 3 pairs of 2 consecutive outer sides of the hexagon perimeter formed of a first of the 2 consecutive sides having a first curvature and a second of the 2 consecutive sides having a second curvature that is opposite the first curvature, to require an installation of another tile to each of the first or second curvature to have the second or first curvature. The composition has each top surface divided internally into 3 different parts extending from each of the 3 pairs of 2 consecutive sides to a center of the tile; the 3 different parts of each tile different than the 3 different parts of each other tile. The composition has the limited number of tile models assembled in random mixture on a surface, such that each of the first and second curvature of 2 consecutive sides of the 3 pairs of one tile are installed against each of the opposing second and first curvature of 2 consecutive sides of the 3 pairs of a different tile. The composition has the random mixture having a 6 tile periphery (e.g., perimeter, boundary or border) of the tile models around a center tile model of each the tile models, with each tile model of the 6 tile periphery being or having an orientation rotated by ⅓ or 120 degrees clockwise or counterclockwise as compared to an orientation of each of the center tile models to create and almost never the same visual effect. Each of the 3 different internal surface parts of each of the limited number of tile models are different than each or all of the 3 different internal surface parts of each of the other of the limited number of tile models, and corresponding surface parts of the 3 different internal surface parts of each of the limited number tile models are configured to create a surface with rarely repeating shapes at triangular intersections between 3 tile models of the limited number tile models with a first tile model at the first orientation angle, a second tile model rotated by 120 degrees as compared to the first orientation angle, and a third tile model rotated by 240 degrees as compared to the first orientation angle.

The new tiles, tile models and assemblies herein allow creation of surfaces with shapes and designs that almost always look different by simply using a limited number of industrially produced tiles or tile models. The same concept can be customized by modifying the perimeter outer curvature shapes, internal top surface part shapes, styles, colors and/or thicknesses described in reference to individual tile preferences and styles (geometric, contemporary, floral, organic, abstract or other), while keeping the same self-explanatory installation system or method. Concepts herein include embodiments exploiting the potential of hexagon format tile models that allows for 6 sides of perimeter outer curvature shapes that fit together, divided into three internal top surface parts not only by modifying the 2 consecutive sides of the hexagon by curving them and making them opposite so as to force the installation of another tile joined with the same curved side, but also by dividing the same hexagon internally into 3 different parts, referred to and delimited with each pair of curved sides with the same shape. Using these embodiments, it is possible to then create a limited number of tiles or tile models that once assembled or laid on a surface, mixed randomly where the same curved sides must necessarily fit together, automatically create different shapes. The fact that these embodiments include pairs of adjacent sides, curved opposites, may cause the constrained installation of each subsequent tile to be with a rotation of 120° always modifying not only the shape but its installation rotation: this creating a surprising and nearly never the same visual effect. The industrial production of these limited number of tiles or tile models now make it possible to obtain shapes of tile assemblies and assembly intersections with a look of rarely never the same and nearly non-repetitive shapes and designs with simple and fast installation.

Each of the tiles or tile models may include or be made of at least one of wood, plywood, solid wood, particle wood/board, paper, plastic, linoleum, formica, composite, tile, marble or ceramic. Each of the tiles, tile models and/or assemblies may be attached to (e.g., installed on or assembled onto or covering) a surface of one of a wall, a ceiling, a table, a balcony, a fireplace (outer or inner) and/or a floor. Each of the tiles, tile models or assemblies may include an adhesive (e.g., glue, nails, screws, epoxy, resin, magnetic) attaching the tiles to the surface. Each of the tiles, tile models or assemblies may be or be configured to be assembled on a surface of that is indoor, outdoor, in weather conditions, under water, on a bridge, on a building exterior and/or in space.

The tiles models herein may be tile models of surface tiles to form tile assemblies to create a surface with rarely repeating designs and shapes at triangular intersections of the tile models. The tile models may be used to form a tile surface formed from a plurality of unique tile types (e.g., the tile models) with unique connecting surfaces. The tile models may be used to form a surface composed of rarely repeating patterns formed from a plurality of unique tile types and connecting surfaces.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” or “number” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. Tile models of surface tiles to form tile assemblies to create a surface with rarely repeating designs and shapes at triangular intersections of the tile models, the tile models comprising:
a limited number of between four and six tile models each having a top surface, a bottom surface and a perimeter of 6 sides with 3 joined pairs of the sides having 3 outer curvature shapes when each tile model is at a first orientation angle;
wherein each of the 3 outer curvature shapes includes a female shaped side having a shape of a first area removed from the female shaped side and an adjacent male shaped side having the shape of the first area added to the male shaped side;
wherein the male shaped side of a tile model fits with no gaps into a corresponding female shaped side of another tile;
each tile model having 3 different corresponding ones of internal top surface parts projecting inwards from the 3 outer curvature shapes to 3 joined pairs of internal sides having 3 internal curvature shapes that connect at an internal location of each tile model;
wherein each of the 3 different internal surface parts of each of the limited number of tile models are different than each of the 3 different internal surface parts of each of the other of the limited number of tile models, and
wherein corresponding surface parts of the 3 different internal surface parts of each of the limited number tile models are configured to create a surface with rarely repeating shapes at triangular intersections between 3 tile models of the limited number tile models with a first tile model at the first orientation angle, a second tile model rotated by 120 degrees as compared to the first orientation angle, and a third tile model rotated by 240 degrees as compared to the first orientation angle.

2. The tile models of claim 1, wherein each triangular intersection is one of an intersection including three corners of three different tile models of the limited number of tile models having corresponding outer curvature shapes or ⅓ irregular part intersections of the tile edges of the three different tile models.

3. The tile models of claim 1, further comprising the tile assembly having columns and rows of a random order sequences of the limited number of tile models joined to each other at corresponding male shaped sides and female shaped sides, such that no gaps are formed between the corresponding male shaped sides and female shaped sides,
wherein the sequences include a first tile model at the first orientation angle and each tile model joined to the first tile model rotated by one of 120 degrees or 240 degrees as compared to the first orientation angle.

4. The tile models of claim 3, wherein the random order sequences are random orders of the limited number of tile models per each of a number of the limited number of tile models.

5. The tile models of claim 1, the 3 different internal surface parts having at least 3 different sectioned styles; wherein the 3 different sectioned styles of each of the limited number of tile models are different than the 3 different sectioned styles of each of the other of the limited number of tile models,
wherein corresponding sectioned styles of the 3 different sectioned styles of each of the limited number of tile models are configured to create the surface with rarely repeating designs at the triangular intersections.

6. The tile models of claim 1, the 3 different internal surface parts of each limited number of tile models having 3 different colors; the 3 colors of each tile model of the limited number of tile models are a same color the 3 colors,
wherein corresponding colors of the 3 same 3 colors of each of the limited number of tile models are configured to create the surface with the rarely repeating designs at the triangular intersections.

7. The tile models of claim 1, wherein the sequences include the triangular intersections between the 3 tile models of the limited number of tile models with a first tile model at the first orientation angle, a second tile model rotated by 120 degrees as compared to the first orientation angle, and a third tile model rotated by 240 degrees as compared to the first orientation angle.

8. The tile models of claim 1, wherein each intersection has corresponding ones of the 3 different internal surface parts of the first, second and third tile models; and wherein the intersection has a same color of the first, second and third tile models.

9. The tile models of claim 1, wherein each tile model includes one of wood, plywood, solid wood, particle wood/board, paper, plastic, linoleum, formica, composite, tile, marble or ceramic; further comprising a tile surface formed from a plurality of tiles of each of the tile models, and wherein the assembly is attached to a surface of one of a wall, a ceiling, a table or a floor; and wherein the assembly includes an adhesive attaching the tile models to the surface.

10. The tile models of claim 1, wherein the limited number of tile models further include arm shaped splashes of a fourth color extending inwards from the three corners between each of the 3 outer curvature shapes to form a 3 armed accent at each of some of the intersections of the first, second and third tile models.

11. The tile models of claim 10, wherein the 3 different internal surface parts of the limited number of tile models are configured to form a floral bloom pattern at each of the intersections; and wherein the 3 armed accents are configured to form a floral central pistil pattern in some of the floral bloom patterns.

12. The tile models of claim 1, wherein each of the 3 different internal surface parts has a different thickness; and wherein the intersection has a same thickness of the 3 different internal surface parts of the first, second and third tile models; and
wherein the corresponding thickness of a same 3 thickness of each of the limited number of tile models are configured to create the surface with the rarely repeating designs at the triangular intersections.

13. Tile models to form tile assemblies to create a surface with rarely repeating designs and shapes at triangular intersections of the tile models, the tile models comprising:
a limited number of between four and six tile models each having a top surface, a bottom surface and a perimeter of 6 sides, 4 of said sides being hexagonal and 1 joined pair of the sides having 1 outer curvature shapes when each tile model is at a first orientation angle;
wherein each of the 1 outer curvature shape includes a female shaped side having a first area removed from the female shaped side and an adjacent male shaped side having the first area added to the male shaped side;
wherein the male shaped side of a tile model fits with no gaps into a corresponding female shaped side of another tile;
each tile model having 1 different internal top surface part projecting inwards from the 1 outer curvature shapes to 1 joined pair of internal sides having 1 internal curvature shape that connect at an internal location LOC of each tile model;
wherein each of the 1 different internal surface part of each of the limited number of tile models are different than all of the 1 different internal surface part of each of the other of the limited number of tile models, and
wherein the 1 different internal surface part of each of the limited number tile models are configured to create a surface with rarely repeating shapes at triangular intersections between 3 tile models of the limited number tile models with a first tile model at the first orientation angle, a second tile model rotated by 120 degrees as compared to the first orientation angle, and a third tile model rotated by 240 degrees as compared to the first orientation angle.

14. The tile models of claim 13, wherein each triangular intersection is an intersection including three corners of three different tile models of the limited number of tile models.

15. The tile models of claim 13, each of the 1 different internal surface parts having at least 1 different sectioned style; wherein the 1 different sectioned style of each of the limited number of tile models are different than the 1 different sectioned style of each of the other of the limited number of tile models,
wherein the 1 different sectioned style of each of the limited number of tile models are configured to create the surface with rarely repeating designs at the triangular intersections.

16. The tile models of claim 13, the 1 different internal surface part of each limited number of tile models having 3 different colors; the 3 different colors of each tile model of the limited number of tile models are a same 3 colors;
wherein the 3 different colors of each of the limited number of tile models are configured to create the surface with the rarely repeating designs at the triangular intersections.

17. The tile models of claim 16, wherein the 3 different colors are randomly selected for each of the limited number of tile models, and
wherein the 3 different colors of the limited number of tile models are configured to form a floral bloom pattern at each of the intersections.

18. Tile models to form tile assemblies to create a surface with rarely repeating designs and shapes at triangular intersections of the tile models, the tile models comprising:
a limited number of between four and six tile models each having a top surface, a bottom surface and a perimeter of 6 sides with 3 joined pairs of the sides having 3 outer angled shapes when each tile model is at a first orientation angle;
wherein each of the 3 outer angled shapes includes a female shaped side having a first area removed from the female shaped side and an adjacent male shaped side having the first area added to the male shaped side;
wherein the male shaped side of a tile model fits with no gaps into a corresponding female shaped side of another tile;
each tile model having 3 different corresponding ones of internal top surface parts projecting inwards from the 3 outer angled shapes to 3 joined pairs of internal sides having 3 internal angled shapes that connect at an internal location of each tile model;
wherein each of the 3 different internal surface parts of each of the limited number of tile models are different than each of the 3 different internal surface parts of each of the other of the limited number of tile models, and
wherein corresponding surface parts of the 3 different internal surface parts of each of the limited number tile models are configured to create a surface with rarely repeating shapes at triangular intersections between 3 tile models of the limited number tile models with a first tile model at the first orientation angle, a second tile model rotated by 120 degrees as compared to the first orientation angle, and a third tile model rotated by 240 degrees as compared to the first orientation angle.

19. The tile models of claim 18, wherein the angled shapes may be between 2 and 6 linear segments forming angles at each of their intersections; and
wherein each triangular intersection is an intersection including three corners of three different tile models of the limited number of tile models.

20. The tile models of claim 18, wherein of the limited number of tile models is configured to form an assembly with a surface having rarely repeating angled shapes at intersections using joined pairs of angled sides of linear segments at the intersections.

21. The tile models of claim 18, wherein each of the limited number of tile models is configured to form an assembly with a surface having rarely repeating geometric designs by using 3 different corresponding ones of the internal top surface parts at the intersections.

22. The tile models of claim 18, the 3 different internal surface part of each limited number of tile models having 3 different colors; the 3 different colors of each tile model of the limited number of tile models are a same 3 colors,
wherein the 3 different colors of each of the limited number of tile models are configured to create the surface with the rarely repeating geometric designs at each of the triangular intersections.
